(19) United States
(12) Patent Application Publication
(10) Pub. No.: US 2006/0009216 A1
(43) Pub. Date: Jan. 12, 2006

(54) Multiple mode scanning

(76) Inventors: William E. Welnick, Poway, CA (US); William P. Alberth JR., Crystal Lake, IL (US); Charles P. Binzel, Bristol, WI (US)

Correspondence Address: MOTOROLA INC, 600 NORTH US HIGHWAY 45, ROOM AS437, LIBERTYVILLE, IL, 60048-5343, US

(21) Appl. No.: 10/880,930

(22) Filed: Jun. 30, 2004

(51) Int. Cl. H04Q 7/20

(52) U.S. Cl. 455/434

(57) ABSTRACT

A method (200) for scanning of channels by a multi-mode communication device includes the steps of making a scan list (230) operative for more than one mode, modifying the scan list (245) to remove all non-current-mode systems, and sequentially scanning (450) a highest priority channel on the modified scan list. If the communication device has recently found service on a particular system in a first mode, the communication device will only search for systems that are associated with that first mode. This use of a modified scan list applies both to power up scanning situations and scanning after power up situations. Modifying a scan list to remove all non-current mode systems allows the multi-mode communication device to avoid scanning for systems that are geographically unavailable and instead acquire a system in less time and with less power consumption.

### FIELD OF THE DISCLOSURE

This disclosure relates generally to communication devices and scanning for service using a multiple mode communication device.

### BACKGROUND OF THE DISCLOSURE

Some communication devices, such as cellular telephones, cordless telephones, computers with communication access, and hybrids or combinations of these devices, can operate in more than one mode to communicate with more than one communication network. In order for a single communication device to operate in multiple modes, the communication device searches for available communication networks upon power up and sometimes after power up.

Scanning for available communication networks on all modes where the communication device is operational, however, is a time-consuming and power-consuming operation. There is an opportunity for a scanning mechanism that reduces power consumption and quickly finds an available communication network. The various aspects, features and advantages of the disclosure will become more fully apparent to those having ordinary skill in the art upon careful consideration of the following Drawings and accompanying Detailed Description.

### BRIEF DESCRIPTION OF THE DRAWINGS

FIG. 1 shows a block diagram of a communication device for multiple mode scanning according to a preferred embodiment.

FIG. 2 shows a flowchart for a power up scan by a communication device for multiple mode scanning according to the preferred embodiment.

FIG. 3 shows a flowchart for a power down by a communication device for multiple mode scanning according to the preferred embodiment.

FIG. 4 shows a flowchart of a scan after power up by a communication device for multiple mode scanning according to the preferred embodiment.

FIG. 5 shows a sample scan list according to the preferred embodiment.

### DETAILED DESCRIPTION OF THE PREFERRED EMBODIMENTS

A method for scanning of channels by a multi-mode communication device includes the steps of making a scan list operative for more than one mode, modifying the scan list to remove all non-current-mode systems, and sequentially scanning a highest priority channel on the modified scan list. If the communication device has recently found service on a particular system in a first mode, the communication device will only search for systems that are associated with that first mode. This use of a modified scan list applies both to power up scanning situations and scanning after power up situations. Modifying a scan list to remove all non-current mode systems allows the multi-mode communication device to avoid scanning for systems that are geographically unavailable and instead acquire a system in less time and with less power consumption.

In this Detailed Description, the term “multiple mode” refers not only to different radio access technologies (RATs, also called air interfaces), but also to similar air interface protocols used at different frequency bands. For example, code division multiple access (CDMA) cellular phone systems operate at the 800 MHz frequency band and the 1900 MHz frequency band in the United States. Additionally in the United States, a Global System for Mobile communication (GSM) cellular phone system operates at the 1900 MHz frequency band. In Europe, there are GSM cellular phone systems operating on the 900 MHz and 1800 MHz frequency bands. Depending on the implementation, a communication device with multiple mode scanning may treat the CDMA 800 cellular phone system, the CDMA 1900 cellular phone system, the GSM 900 cellular phone system, and the GSM 1800 cellular phone system as four separate modes. Alternately, the communication device with multiple mode scanning may treat the CDMA 800 and CDMA 1900 cellular phone systems as a first mode and treat the GSM 900 and GSM 1800 cellular phone systems as a second mode. Still further, another embodiment of the communication device with multiple mode scanning may group the CDMA 1900 and GSM 1800 cellular phone systems in a first mode and the CDMA 800 and the GSM 900 cellular phone systems in a second mode.

As another example, a communication device with multiple mode scanning may treat a 900 MHz cordless phone system, a 46/49 MHz cordless phone system, and a CDMA 1900 cellular phone system as three separate modes. Alternately, a communication device with multiple mode scanning may treat the two cordless phone systems as a first mode and the cellular phone system as a second mode.

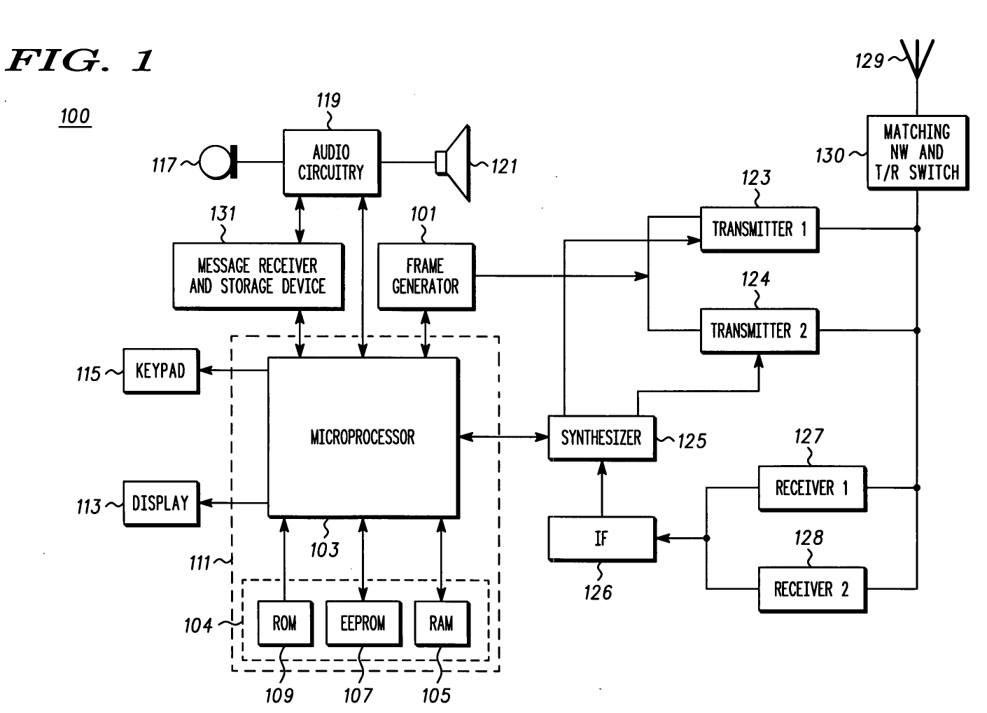

FIG. 1 shows a block diagram of a communication device 100 for multiple mode scanning according to a preferred embodiment. This communication device 100 is a dual-mode cellular radiotelephone with a first mode having CDMA 800 and CDMA 1900 capabilities and a second mode having GSM 900 and GSM 1800 capabilities. Other cellular phone modes, such as Time Division Multiple Access (TDMA), Advanced Mobile Phone System (AMPS), etc., can be substituted or added to create a tri-mode or other variants of a multi-mode communication device. It is also appropriate to use multiple mode scanning with other types of multi-mode communication devices, such as a cordless-cellular telephone, an FM/AM/satellite radio, or a laptop computer with WLAN-cellular transceivers.

For scanning, several hardware components, such as radio-frequency assemblies and base-band assemblies, must be active and supplied with power. Radio-frequency assemblies commonly include an amplifier, mixer, demodulator, and oscillator. Base-band assemblies usually have a digital signal processor, microprocessor, and memory.

A frame generator 101 and a microprocessor 103 combine to generate the necessary communication protocols needed to operate in the GSM 900/1800 and CDMA 800/1900 cellular systems. The microprocessor 103 uses memory 104 such as a random access memory (RAM) 105, an electrical erasable programmable read-only memory (EEPROM) 107 and a read-only memory (ROM) 109. Alternate memory devices can be used, and the memories can be consolidated in one package 111. The microprocessor 103 and the memory 104 work together to execute the steps necessary to generate the protocol and to perform other functions for the communication device, such as writing to a display 113, accepting information from a keypad 115, controlling a frequency synthesizer 125, or performing steps needed to amplify a signal. The frame generator 101, in conjunction with the microprocessor 103, processes audio transformed by the audio circuitry 119 from a microphone 117 and to a speaker 121.

A transceiver processes radio frequency signals to and from the communication device 100. For this dual-mode cellular radiotelephone, two transmitters 123, 124 transmit through an antenna 129 using carrier frequencies produced by a frequency synthesizer 125. Information received by the communication device's antenna 129 enters receivers 127, 128 through a matching network and transmit/receive switch 130. At least one of the receivers 127, 128 demodulates the symbols comprising the message frame using an intermediate frequency (IF) section 126 and the carrier frequencies from frequency synthesizer 125. The transmitters and receivers are collectively called a transceiver. Those skilled in the art will recognize that other transceiver architectures can be substituted, for example the two transmitters may combined in one subsystem, the two receivers may be combined into a subsystem, or the intermediate frequency section 126 may be eliminated by using a direct conversion receiver. The communication device 100 may optionally include a message receiver and storage device 131 including digital signal processing means. The message receiver and storage device 131 could be, for example, a digital answering machine or a paging receiver.

Because this is a multi-mode communication device, upon power-up (and after power-up) the communication device has several options for finding a serving network. Generally speaking for a dual-mode device, there will be classifications available for a home network for a first mode, a home network for a second mode, at least one preferred network for the first mode, at least one preferred network for the second mode, “roam” networks for the first mode, “roam” networks for the second mode, other networks for the first mode, and other networks for the second mode. With more than two modes, there will be opportunities for home, preferred, roam, and other networks in the additional modes.

Some service providers operate modes that are exclusive to specific geographic regions. For example, a service provider may operate a CDMA network in North America and operate a GSM network in Western Europe. By using multiple mode scanning during power-up and subsequent to power-up of a communication device, the communication device eliminates spending time and battery power on searching for service that is not available at the geographic location where it is being powered-up. This scanning takes advantage of systems that are not co-located.

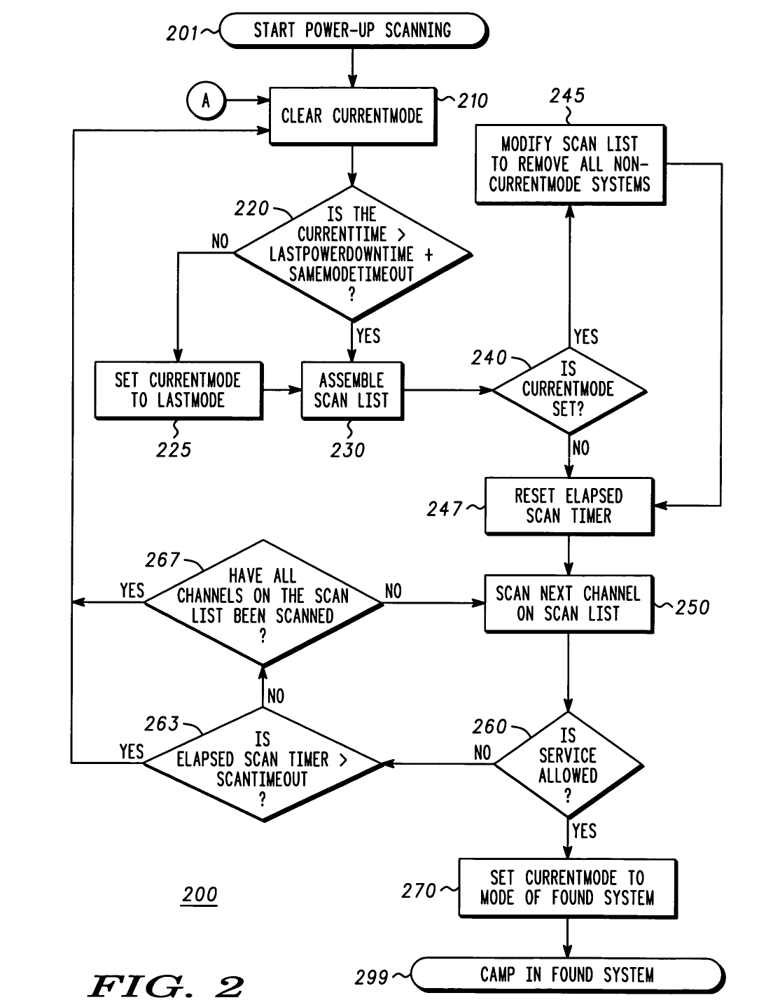

FIG. 2 shows a flowchart 200 for a power up scan by a communication device for multiple mode scanning according to the preferred embodiment. In a cellular telephone environment, this scan is sometimes referred to as “cell selection.” In step 201, the flowchart starts power-up scanning upon powering up the communication device. Step 210 deletes any value in memory that is assigned to a “current mode” variable CURRENTMODE. At this point in time, the communication device is not aware of a current mode. Step 220 determines if the current time is less than a variable LASTPOWERDOWNTIME plus a variable SAMEMODETIMEOUT. The variable LASTPOWERDOWNTIME represents the most recent time that the communication device was properly powered down. The variable SAMEMODETIMEOUT represents a predetermined time interval.

If the communication device is starting its scan within the period determined by the variable SAMEMODETIMEOUT since the communication device last properly powered down, step 225 sets the variable CURRENTMODE to the value of variable LASTMODE. This means that the communication device will scan only for networks that operate using the same mode as the communication device was operating on at the time it powered down. Otherwise, the flowchart goes straight from step 220 to step 230.

The SAMEMODETIMEOUT variable can be retained in the communication device memory as set by a service provider, or it can be manually adjusted by the user of the communication device, or it can be automatically adjusted depending on some predetermined variables. For example, if the service provider intends the communication device to operate in a first mode in North America and a second mode in Western Europe, the SAMEMODETIMEOUT variable can be set at six hours, which represents an expected minimum time needed to get from North America to Western Europe. Alternately, if a user intends the communication device to operate in a first mode at home and a second mode at the office, the user can set the SAMEMODETIMEOUT variable to an expected minimum commute time between home and office.

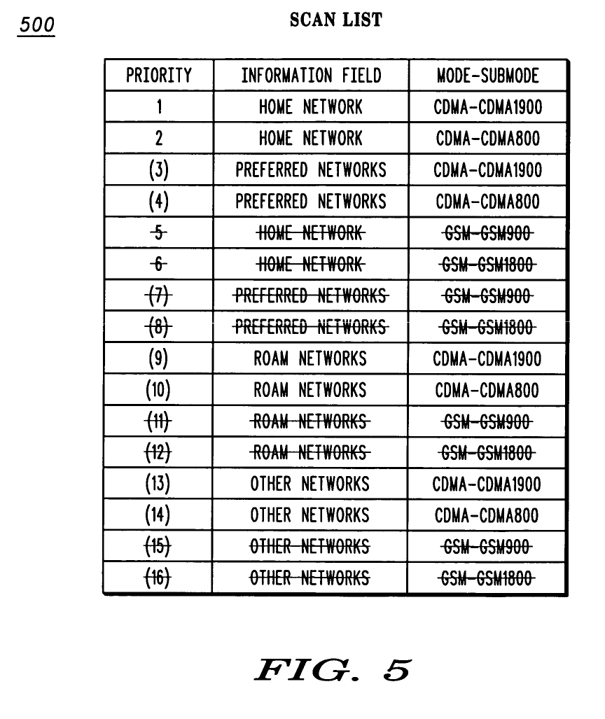

Step 230 assembles a scan list. The scan list is a prioritized list of channels that will be described in more detail with reference to FIG. 5. The scan list can be assembled from a variety of sources and ranked according to a variety of preferences. Network identifiers that become items in a scan list are often available from a permanent memory (ROM) in the communication device, from a removable memory such as a subscriber identity module (SIM card) or a removable user identity module (RIUM), or a non-permanent memory (RAM) in the communication device that is downloaded using either a wireless or wired connection. The scan list at this step of the preferred embodiment includes all allowed channels from all modes the communication device can operate on.

If step 240 determines that the variable CURRENTMODE is not empty (i.e., CURRENTMODE is set in step 225), step 245 removes all entries from the scan list that are not associated with the CURRENTMODE variable. Thus, when step 245 has completed, all the networks on the scan list will be associated with the same mode as the communication device was operating on when it last properly powered down; all the networks that were associated with non-CURRENTMODE modes will have been removed. If step 240 determines that the variable CURRENTMODE is empty, no networks will be removed from the scan list before the flowchart moves to step 247, where an elapsed scan timer is reset.

Next, step 250 sequentially scans channels associated with the networks on the scan list. If step 260 determines that service is not allowed on the channel being scanned, step 263 checks the elapsed scan timer to see whether it has exceeded a predetermined SCANTIMEOUT variable. In this preferred embodiment, the SCANTIMEOUT variable equals the SAMEMODETIMEOUT variable. If the predetermined SCANTIMEOUT variable has not been exceeded, step 267 checks whether all channels on the scan list have been scanned. If not all the channels on the scan list have been scanned, the flowchart returns to step 250. If step 260 determines that service is allowed on the channel being scanned, step 270 sets the variable CURRENTMODE equal to the value of the mode of the found system. Step 299 ends the flowchart with camping within the found network.

If step 263 determines that the elapsed scan timer has exceeded the SCANTIMEOUT variable, or if step 267 determines that all the channels on the scan list have been scanned with no service allowed, the flow returns to step 210 where the CURRENTMODE variable is cleared. During this second pass through the flowchart, a scan list is assembled, potentially modified, and sequentially scanned. If, for example, a user is traveling from North America to Western Europe but does not power down the communication device for a six hour period of time represented by the SAMEMODETIMEOUT, the second pass through the flow chart will check again the current time in step 220 and set (or not set) the CURRENTMODE variable according to the flow chart. This allows the communication device, in the event of an unexpected situation or a software bug, to rebuild the scan list and eventually scan all the channels on an unmodified scan list.

Thus, the flowchart allows for assembling a scan list, modifying the scan list to remove all non-CURRENTMODE systems, and scanning using the modified scan list. By scanning only channels associated with the mode last servicing the communication device, the communication device saves time and battery power. If the communication device supports modes that operate in mutually exclusive geographic areas, this scanning produces a performance improvement over scanning in all modes supported by the communication device.

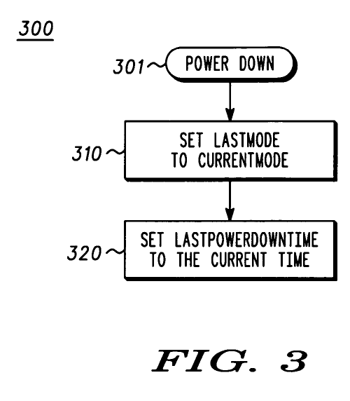

FIG. 3 shows a flowchart 300 for a power down by a communication device for multiple mode scanning according to the preferred embodiment. Upon power down of the communication device, as noted in step 301, step 310 sets the variable LASTMODE to the value in the variable CURRENTMODE. This allows the communication device to recall the last mode that serviced the communication device. Next, step 320 sets the variable LASTPOWERDOWNTIME equal to the current time. These two variables, LASTMODE and LASTPOWERDOWNTIME, are used in the flowchart of FIG. 2 to determine whether to modify the scan list in step 245 of FIG. 2.

If the communication device is powered up within the time period represented by SAMEMODETIMEOUT since the time represented by the LASTPOWERDOWNTIME variable, the communication device will scan only for the network represented by the LASTMODE variable. This allows the communication device to save time and battery energy in finding a serving system.

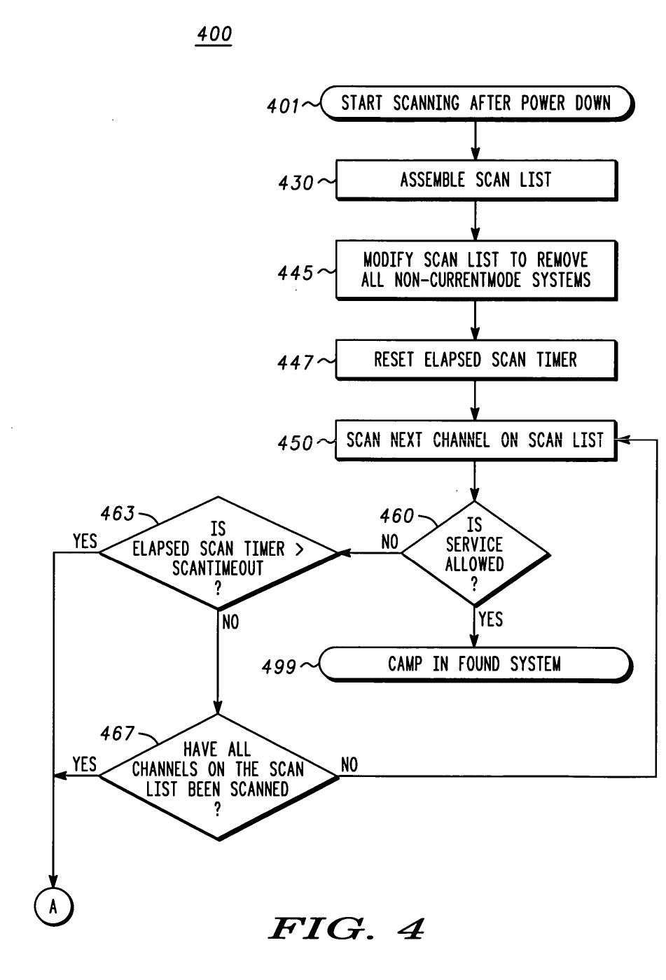

FIG. 4 shows a flowchart 400 of a scan after power up by a communication device for multiple mode scanning according to the preferred embodiment. A non-power up scanning can occur when a signal is lost or there is another type of abnormal disconnection of the communication device from its serving system. Abnormal disconnection may be caused by network artifacts such as maintenance cycles or signaling errors. Flowchart 400 is essentially a subset of flowchart 200 shown in FIG. 2. Thus, it is possible to use flowchart 200 for both power up scanning and scanning after power up. Step 401 starts scanning after a power up. Step 430 assembles a scan list similar to step 230. Step 445 modifies the scan list to remove all entries corresponding to systems that are not of the type represented by the variable CURRENTMODE.

Next, step 447 resets an elapsed scan timer. Step 450 sequentially scans channels associated with the systems in the modified scan list. Step 460 determines if the current channel allows service. If the current channel does not allow service, step 463 checks the elapsed scan timer to see whether it has exceeded a predetermined SCANTIMEOUT variable. If the predetermined SCANTIMEOUT variable has not been exceeded, step 467 checks whether all channels on the scan list have been scanned. If not all the channels on the scan list have been scanned, the flowchart returns to step 450 and scans the next channel in the modified scan list. If step 460 determines that the current channel allows service, step 499 camps the communication device in the system of the current channel.

If step 463 determines that the elapsed scan timer has exceeded the SCANTIMEOUT variable, or if step 467 determines that all the channels on the scan list have been scanned with no service allowed, the flow returns to step 210 in FIG. 2 where the CURRENTMODE variable is cleared. During this pass through the flowchart 200 of FIG. 2, a scan list is assembled, potentially modified, and sequentially scanned. If, for example, an unexpected situation or a software bug causes the communication device to improperly assemble the scan list in step 430 or improperly modify the scan list in step 445, the flow will revert to the full flowchart 200 in FIG. 2. If a time period represented by the variable SCANTIMEOUT has elapsed without the communication system successfully camping on a system, the communication device will rebuild the scan list that includes all the entries and scan through the unmodified scan list.

Because the variable CURRENTMODE is set during a power-up scan during step 270 shown in FIG. 2, any non-power-up scan presumes that the system represented by the CURRENTMODE variable will still be available for a subsequent non-power-up scan. By making this presumption, the communication device will find a system more quickly, and with less power consumption, than if the presumption was not made.

FIG. 5 shows a sample scan list 500 according to the preferred embodiment. The scan list is a prioritized list of channels that a communication device, such as the communication device 100 shown in FIG. 1, can create and maintain in memory 104. The channels on the scan list can be obtained from sources such as ROM and RAM in the communication device, a SIM card or a RUIM. The example communication device has a first mode of CDMA and a second mode of GSM. The CDMA mode represents two systems, a CDMA800 system and a CDMA1900 system. The GSM mode represents two systems, a GSM900 system and a GSM1800 system. In this preferred embodiment, each system is included as a separate submode in the scan list. Another embodiment can eliminate the submodes, and have only the CDMA and GSM modes, which does not allow for quite as much flexibility in changing mode definitions. For example, if the two modes of a communication device were to change from CDMA800/CDMA1900 and GSM900/GSM1800 to CDMA1900/GSM1800 and CDMA800/GSM900, there would be little change needed to the scan list shown.

In this sample, the CURRENTMODE variable of the communication device refers to the CDMA mode representing both the CDMA 800 and CDMA 1900 cellular phone networks. Thus, in this sample scan list 500, the channels associated with non-CURRENTMODE systems have been struck-out to show that the scan list has been modified to remove all non-CURRENTMODE systems as described in step 245 of FIG. 2 and step 445 of FIG. 4. Because the non-CURRENTMODE system channels have been removed, the communication device will first scan for the home network of the CDMA 1900 system. If the scan is unsuccessful, the communication device will scan preferred networks of the CDMA 1900. (The parentheses around a priority number indicates that more than one channel is usually listed under that priority number.) If none of those scans are successful, the communication device will scan for roam networks of the CDMA system. If none of those scans are successful, the communication device will scan for other networks of the CDMA system. If a time period represented by the variable SCANTIMEOUT has elapsed without the communication system successfully camping on a system, the communication device will rebuild the scan list that includes all the entries and scan through the unmodified scan list.

Thus, multiple mode scanning provides a quicker, lower-power-consumption alternative to traditional multi-mode scanning methods. By setting up a scan list, removing non-current mode systems from the scan list to create a modified scan list, and sequentially scanning through the modified scan list until a system is found, a communication device with multiple mode scanning saves battery power and time in locating a serving system.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

We claim:

1. A method for scanning of channels by a multi-mode communication device comprising the steps of:
making a scan list, having a prioritized list of channels, operative for more than one mode;
modifying the scan list, to remove all non-current-mode systems, to create a modified scan list; and
scanning a highest priority channel on the modified scan list.

2. A method according to claim 1 further comprising the step of:
failing to modify the scan list to remove all non-current-mode systems to create a modified scan list, if a current time is greater than a time that the multi-mode communication device last powered down plus a same mode time out time period.

3. A method according to claim 1 further comprising the step of:
if service is not allowed on the highest priority channel on the modified scan list, scanning a next highest priority channel on the modified scan list.

4. A method according to claim 3 further comprising the steps of:
resetting an elapsed scan timer, after the step of modifying the scan list; and
returning to the step of making a scan list, if the elapsed scan timer exceeds a scan time out time period before the multi-mode communication device camps in a found system.

5. A method according to claim 3 further comprising the step of:
returning to the step of making a scan list, if all channels on the modified scan list have been scanned before the multi-mode communication device camps in a found system.

6. A method according to claim 1 further comprising the steps of:
if service is allowed on the highest priority channel on the modified scan list, storing a mode associated with a system of the highest priority channel as a current mode; and
camping in the system of the highest priority channel.

7. A method according to claim 1 further comprising the step of:
if the multi-mode communication device has been properly powered down within a predetermined period prior to a current time, setting a last mode to a mode in use prior to the power down.

8. A method according to claim 7 further comprising the step of:
setting the current mode to the last mode if a current time is not greater than a time that the multi-mode communication device last powered down plus a same mode time out time period

9. A method according to claim 1 further comprising the steps of:
if the multi-mode communication device has not been properly powered down within a predetermined period prior to a current time, setting no current mode system.

10. A method according to claim 1, wherein the multi-mode communication device is operative using both GSM and CDMA.

11. A method according to claim 7, wherein a first mode is CDMA and a second mode is GSM.

12. A communication device comprising:
a memory configured to store a scan list having a prioritized list of channels operative for a first mode and a second mode;
a microprocessor configured to modify the scan list to create a modified scan list having a prioritized list of channels operative for only the first mode; and
a receiver configured to scan a highest priority channel in the modified scan list.

13. A communication device according to claim 12 wherein the receiver is further configured to scan a next highest priority channel on the modified scan list if service is not allowed on the highest priority channel.

14. A communication device according to claim 12 wherein the memory is further configured to store the first mode if service is allowed on the highest priority channel on the modified scan list.

15. A communication device according to claim 14 wherein the microprocessor is further configured to camp in a system associated with the highest priority channel.

16. A method for modifying a scan list comprising:
making a scan list, having a prioritized list of channels, operative for more than one mode;
removing all non-current mode systems from the scan list to create a modified scan list.

17. A modified scan list comprising:
a prioritized list of channels, each channels associated with a mode,
wherein any channel associated with a non-current mode is removed.
